(19) United States
(12) Patent Application Publication
(10) Pub. No.: US 2005/0252555 A1
(43) Pub. Date: Nov. 17, 2005

(54) Valve and pressure regulator biasing assemblies

(76) Inventors: Ronnie Browne, Streetsboro, OH (US); Mark Slovasky, Mayfield Heights, OH (US); Scott Proper, Stow, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/089,674

(22) Filed: Mar. 25, 2005

Related U.S. Application Data
(60) Provisional application No. 60/556,216, filed on Mar. 25, 2004.

(51) Int. Cl. F16K 31/12

(52) U.S. Cl. 137/505

(57) ABSTRACT

An embodiment of the present invention relates to self-contained biasing assemblies for use with fluid flow devices or assemblies, such as valve and pressure regulator assemblies. A self-contained biasing assembly of a fluid flow assembly can be readily changed without requiring substantial disassembly of the fluid flow assembly. The biasing force applied to components within the fluid flow assembly can be changed by changing the biasing assembly.

### RELATED APPLICATIONS

The present application claims priority from U.S. provisional application Ser. No. 60/556,216, entitled “VALVE AND PRESSURE REGULATOR SPRING PACKAGE,” filed on Mar. 25, 2004, which is incorporated herein by reference in its entirety.

### FIELD OF THE INVENTION

The present invention relates generally to fluid flow arrangements. In particular, the invention relates to fluid flow arrangements that provide for exchangeable self-contained biasing assemblies.

### BACKGROUND OF INVENTION

Many fluid flow assemblies, such as diaphragm valves and dome loaded pressure regulators, use a spring to bias a fluid control component into a position relative to the path of fluid flow to control flow through the assembly. In a valve assembly, a compression spring is usually integrally incorporated into the assembly and provides a force that opposes a pneumatic or manual actuator. In most valve assemblies this spring exerts enough force to deflect a diaphragm web or other sealing component and establish a seal against a predetermined fluid pressure. In the case of a pressure regulator assembly, the spring is also normally integrally incorporated into the assembly and creates a predetermined pressure drop across the seat that keeps the downstream pressure constant over a given flow range. In some cases the spring also provides a force to a push rod located between two sealing components to keep an assembly together.

FIG. 1 shows a prior art valve disclosed in U.S. Pat. No. 5,261,442. This valve includes a spring assembly 2, 4 that is captured as part of a valve assembly 5. In the illustrated prior art valve, in order to change the springs, the valve assembly 5 must be substantially disassembled.

### SUMMARY

An embodiment of the present invention provides self-contained biasing assemblies for use with fluid flow devices or assemblies, such as valve and pressure regulator assemblies. A self-contained biasing assembly of a fluid flow assembly can be readily changed without requiring substantial disassembly of the fluid flow assembly. The biasing force applied to components within the fluid flow assembly can be changed by changing the biasing assembly.

One embodiment of the invention is directed to a biasing assembly for use in a fluid flow assembly, where the fluid flow assembly includes a fluid control member that is movable from a first position to a second position. The biasing assembly includes a housing and a biasing member located within the housing. The biasing assembly is assembled into the fluid flow assembly such that the biasing member biases the fluid control member towards the first position. The biasing assembly can be removed from the fluid flow assembly as a self-contained unit and replaced such that a biasing force applied to the fluid control member is changed.

An embodiment of the invention is directed to a biasing assembly for use as a component of a fluid flow assembly, where the fluid flow assembly includes a fluid control member that is movable from a first position to a second position. The biasing assembly is comprised of a housing, a base member coupled to the housing; and a biasing member located within the housing and the base member. The biasing assembly is assembled with the fluid flow assembly such that the biasing member biases the fluid control member towards the first position. The biasing assembly can be removed from the fluid flow assembly as a self-contained unit and replaced such that a biasing force applied to the fluid control member is changed.

An embodiment of the invention the biasing member is a conical spring. The conical spring allows for an approximately constant biasing force to be applied to components within a fluid flow assembly across the working displacement of that spring.

### BRIEF DESCRIPTION OF THE DRAWINGS

FIG. 1 is a cross-sectional view of prior art valve assembly disclosed in U.S. Pat. No. 5,261,442;

FIG. 2 is a schematic view of a fluid flow assembly;

FIG. 3 is a perspective view of a fluid flow assembly;

FIG. 4 is a side view of a fluid flow assembly;

FIG. 5 is a cross-sectional view of a fluid flow assembly taken along the plane indicated as A-A in FIG. 4;

FIG. 6 is a top view of a fluid flow assembly;

FIG. 7 is a cross-sectional view of a fluid flow assembly taken along the plane indicated as B-B in FIG. 6;

FIG. 8 is an exploded view of a fluid flow assembly;

FIG. 9 is a perspective view of a biasing assembly;

FIG. 10 is a top view of a biasing assembly; and

FIG. 11 is a cross-sectional view of a biasing assembly taken along the plane indicated by C-C in FIG. 10.

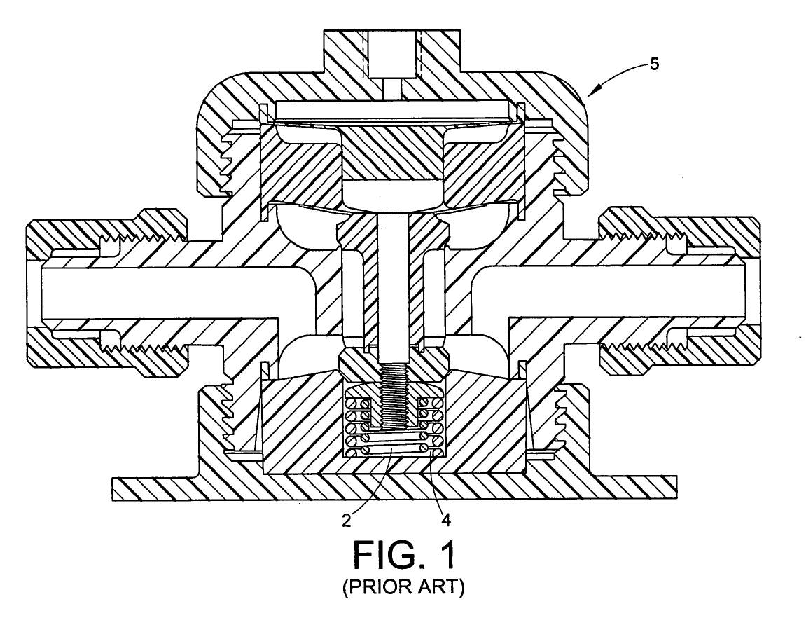

### EXEMPLARY EMBODIMENT OF THE INVENTION

An embodiment of the invention provides self-contained biasing assemblies for use with fluid flow assemblies. Self-contained biasing assemblies are exchangeable units and allow for changing the biasing force applied by the biasing assembly to components within the fluid flow assembly. A self-contained biasing assemblies allows a biasing member to remain in proper alignment upon exchange and allows for easy servicing of the biasing member.

While the described embodiments herein are presented in the context of exchangeable self-contained biasing assemblies for use with valve and pressure regulator assemblies, those skilled in the art will readily appreciate that the present invention may be used in many different fluid flow assemblies and systems. The examples provided are intended to illustrate the broad application of the invention. The specific design and operation of the systems selected provide no limitation on the present invention except as otherwise expressly noted herein.

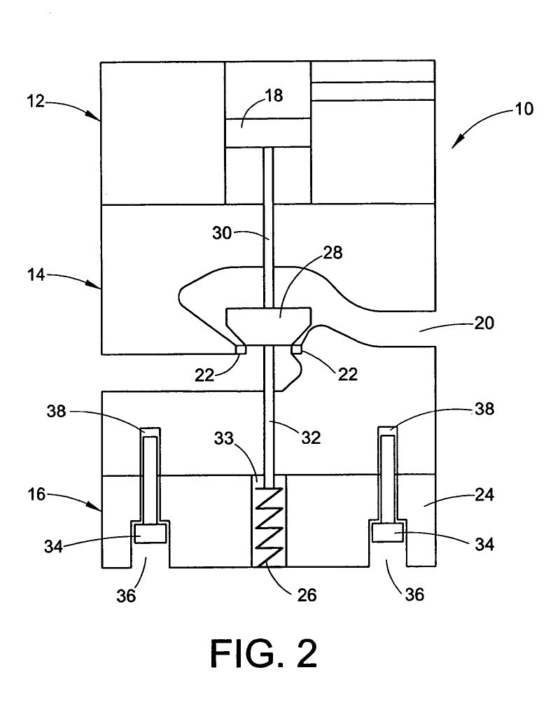

An embodiment of the invention contemplates a removable self-contained biasing assembly which facilitates changing the biasing member of a fluid flow assembly. The biasing member may be changed to adjust the biasing or opposing force that is required to establish a seal in a valve assembly or balance the inlet and outlet pressures in a pressure regulator assembly. FIG. 2 generally schematically illustrates an embodiment of the invention. The illustration shows an assembled fluid flow assembly 10, including an actuator assembly 12, a flow device body 14, and a self-contained biasing assembly 16. The actuator assembly 12 includes an actuation member 18, such as pneumatic piston. The flow device body 14 includes a flow path 20 and a valve seat 22. The biasing assembly 16 includes a housing 24 and a biasing member 26, such as a mechanical spring, contained within the housing 24.

In the example illustrated by FIG. 2, the fluid flow assembly 10 includes a fluid control member 28, such as a diaphragm or plug, and a pair of force transferring stems 30, 32. An upper stem 30 transfers force between the actuation member 18 and the fluid control member 28, while a lower stem 32 transfers force between the biasing member 26 and the fluid control member 28. The actuation member 18 generally applies a downward force and the biasing member 26 generally applies an upward force, with respect to FIG. 2. When the fluid flow assembly 10 is a valve assembly, the downward and upward forces generally interact with one another and establish a force state where the fluid control member 28 may create a seal against the valve seat 22. The assembly can be designed to maintain this seal across a predetermined fluid flow pressure range. When the fluid flow assembly 10 is a pressure regulator assembly the actuation member 18 and biasing member 26 typically interact with one another to balance inlet and outlet pressures by creating a predetermined pressure drop across the valve seat 22 to keep downstream pressure approximately constant over an upstream flow range.

As illustrated in FIG. 2, the biasing assembly 16 is modularly designed. This is to say that the biasing assembly 16 can be decoupled from the fluid flow assembly 10 and removed as one self-contained unit. The housing 24 of the biasing assembly 16 contains the biasing member 26 within the interior of the housing 24. The biasing member 26 comes into contact with the lower stem 32 due to the lower stem 32 entering into the housing 24 through an opening (not numbered) in the housing 24. When the biasing assembly 16 is decoupled from the fluid flow assembly 10, the lower stem 32 is extracted from the housing 24 and the biasing member 26 remains contained and aligned within the housing 24. The alignment of the biasing member 26 within the housing 24 can be maintained by, for instance, walls of a chamber 33 that are designed to accommodate the dimensions of the biasing member. Due to the maintenance of alignment of the biasing member 26 within the housing 24, when a biasing assembly 16 is coupled or recoupled to a fluid flow assembly 10 the lower stem 32 can simply be inserted through an opening in the housing 24, placed into contact with the biasing member 26, and proper alignment of the biasing member 26, lower stem, and other components is complete. This illustrated example shows a single stem 32 transferring force between the biasing member 26 and the fluid flow member 28. It should be understood that any number of components can work in concert to transfer force between a biasing member 26 and a fluid control member 28 and that methods and apparatuses for transferring such force is not limited to examples illustrated.

The biasing assembly 16 is coupled to the flow device body 14 by fasteners 34 that are placed into pre-formed holes 36 in the biasing assembly housing 24 and fastened into threaded holes 38 in the flow device body 14. This specific fastening method is merely an example of the vast possible fastening methods that can be utilized to couple and decouple the biasing assembly 16 with the fluid flow assembly 10. Any method of coupling is incorporated in this invention, provided it allows for coupling and decoupling of a biasing assembly 16 from the fluid flow assembly 10.

The ability to simply or easily couple and decouple biasing assemblies 16 allows for efficiently and effectively changing the biasing force that is applied to a sealing member or fluid control member 28 of an assembly 10. The self-contained arrangement of the biasing assembly 16 provides for methods of quickly adjusting the biasing force to comply with changes in requirements for the fluid flow assembly 10. For instance, if a fluid flow assembly 10 needs to provide a greater or a lesser downstream flow, the assembly 10 can be easily and quickly reconfigured to accommodate the need. A first biasing assembly 16, with a first biasing force, can be disassembled for the fluid flow assembly 10 by removal of fasteners 34. A second biasing assembly 16, with a second biasing force that accomplishes the new requirement, can then be assembled to the fluid flow assembly 10 using the same fasteners 34. With the biasing assemblies 16 being self-contained units, there is no need to specifically place or align the biasing member 26 with respect to other components in the fluid flow assembly 10. The fastening mechanism encourages the biasing assembly 16, and thus the biasing member 26, into proper location and alignment with respect to other components in the fluid flow assembly 10.

The ability to simply and easily couple and decouple biasing assemblies 16 also allows for efficient repair and replacement of damaged or malfunctioning biasing assemblies, as well as efficient general servicing of biasing members and assemblies.

The materials used for all components of the fluid flow assembly 10 can be metal or any of a variety of plastics or other polymers, such as Polytetrafluoroethylene (PTFE). Some components are preferably, but not necessarily, manufactured from metals, such as fasteners, the biasing member, and threaded inserts into which fasteners are secured.

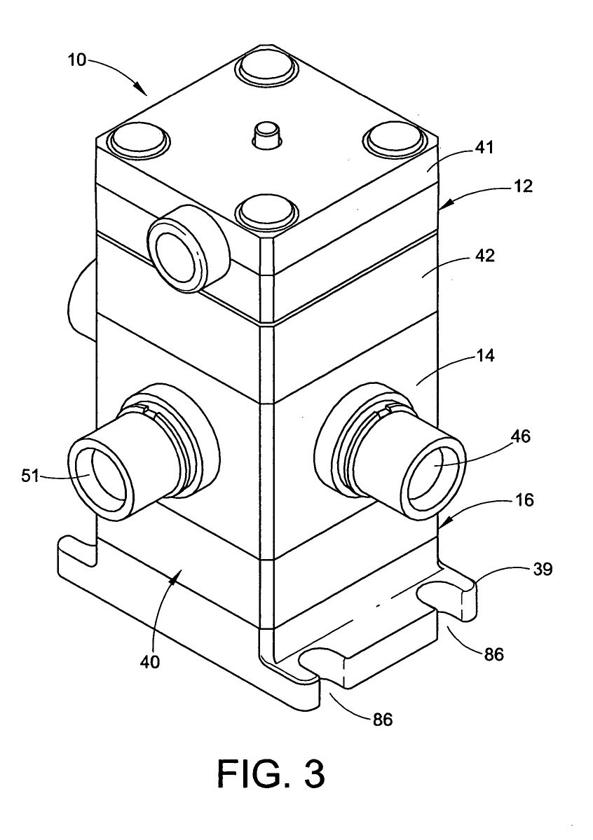

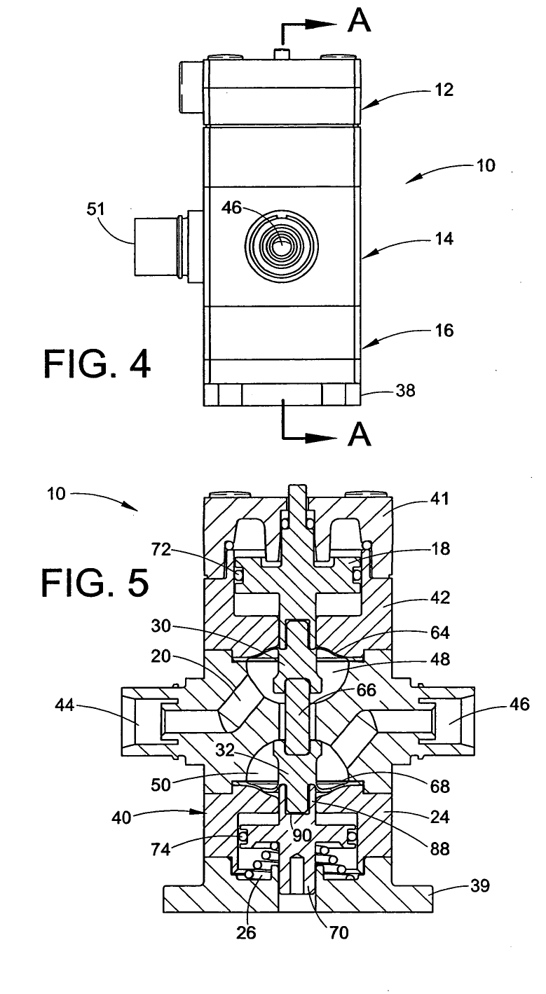

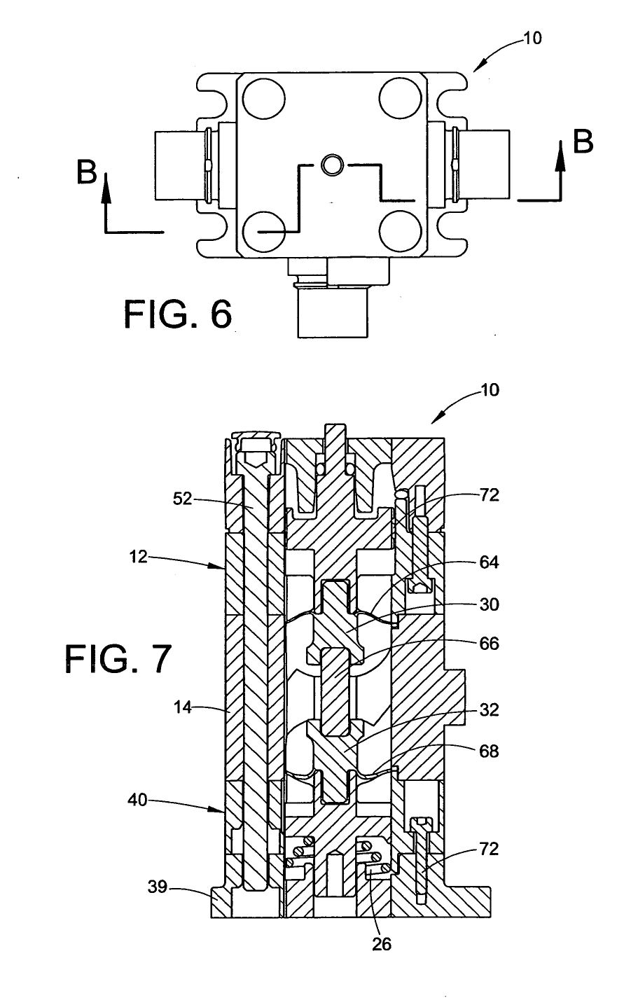

FIGS. 3 though 8 illustrate an example of a complete valve or pressure regulator assembly 10. As shown in FIG. 3, the assembly 10 includes an actuator assembly 12, a flow device body 14, and a biasing assembly 16, which includes an optional mounting plate or base member 39. An example of a mounting plate is disclosed in published World Intellectual Property Organization publication WO 02/088583 A1, entitled “VALVE WITH SNAP CONNECTOR,” filed Apr. 25, 2002, which is incorporated herein by reference in its entirely. The flow device body 14 shown can be used in either a valve assembly or a pressure regulator assembly. The biasing assembly 16 in the illustrated embodiment includes a spring package 40, which is optionally coupled to the mounting plate 39. The mounting plate 39 allows for conveniently securing the assembly 10 to a support. Once the assembly 10 is secured, it can be more easily attached to other components or assemblies in a fluid flow system.

FIG. 5 illustrates in elevation the assembly 10 of FIG. 3 in partial longitudinal cross-section. The actuator assembly 12 includes an actuator cap 41 and an actuator body 42, which houses an actuator piston 18. In this example, the actuator assembly 12 is pneumatic but other actuator technologies may be used as required including hydraulic, manual, and electromechanical.

A flow path 20 in the flow device body 14 includes an inlet port 44, an outlet port 46, an inlet cavity 48, and an outlet cavity 50, which collectively accommodates fluid flow though the flow device body 14. Although ports and cavities are described as inlet and outlet for clarity, it should be understood that those descriptions may be reversed, as flow through the assembly 10 is capable of being reversed. Optionally a third port 51 (best seen in FIG. 3) can be added. The third port 51 can serve as an input port when the assembly 10 is used to blend two fluids or as an output port when the assembly 10 is used to optionally divert fluid to two output paths.

The spring package 40 includes a mechanical spring 26 contained partially within a housing 24. In the example illustrated in FIG. 5, the spring 26 is a conical shaped compression spring 26. The conical spring 26 is designed to provide a near constant spring rate across the working displacement of the spring. This conical spring 26 permits the active coils to nest within one another upon compression. This allows for a lower profile upon full compression than the helical springs 2, 4 described in the prior art. This lower profile can provide for a shorter height needed to accommodate a spring and for a lower overall height of a fluid flow assembly 10. Although the example provided shows the biasing member as a conical spring 26, any other types of biasing members which can be contained in the biasing assembly 16 in a manner that ensures the biasing member is constrained, aligned and easily serviced in a valve or pressure regulator assembly 10 is included in this invention.

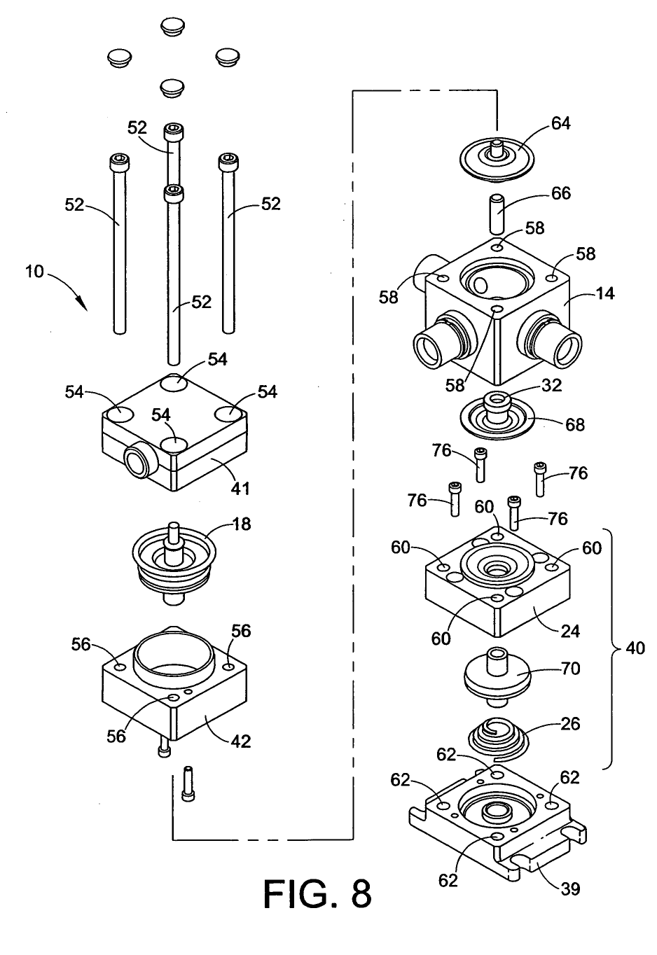

FIGS. 7 and 8 illustrate a fastening mechanism for use in a fluid flow assembly 10. The actuator assembly 12, flow device body 14, spring package 40, and mounting plate 39 are secured into an assembly 10 by four threaded bolts 52. As shown in FIG. 8, the bolts 52 pass though pre-formed holes 54 in an actuator cap 41, pre-formed holes 56 in the actuator body 42, preformed holes 58 in the flow device body 14, and pre-formed holes 60 in the spring package housing 24. The bolts 52 fasten into threaded holes 62 in the mounting plate 39.

The actuator assembly 12 and the biasing assembly 16 provide counteracting forces that work in tandem to open or close the flow path in a valve assembly 10 or to balance the inlet and outlet pressures in a pressure regulator assembly 10. In the example of FIG. 5, a sealing mechanism includes two fluid control members or sealing members. The actuator piston 18 and spring 26 interact through a series of contacts between components. The actuator piston 18 is in contact with and operably drives an upper diaphragm stem 30. The upper diaphragm stem 30 is coupled to an upper diaphragm 64. The upper diaphragm stem 30 is in contact with a push rod 66, which in turn is in contact with a lower diaphragm stem 32. The lower diaphragm stem 32 is coupled to a lower diaphragm 68. The lower diaphragm stem 32 is in contact with a spring guide 70, which is a least partially located within the spring package 40 and in contact with and operably driven by the spring 26. Through this series of contacts, a downward actuator force and an upward spring force are applied to the sealing mechanism. These forces interact to provide a normally open or closed valve position against a give fluid flow when the assembly 10 is used as a valve, or provide a predetermined pressure drop across the seat to regulate flow when the assembly 10 is used as a pressure regulator. These forces may also interact to keep the sealing mechanism in compression, which may alleviate any need for the stems 30, 32 and the push rod 66 to be coupled or connected to one another. In addition, keeping the sealing mechanism in compression lessens concerns of material creep when components are manufactured from polymeric materials.

The upper diaphragm 64 seals the actuator assembly 12 from the flow of fluid through the valve 14 and the lower diaphragm 68 seals the biasing assembly 16 from this flow stream. An o-ring or other seal device 72 can be provided on the piston 18 to further seal components in the actuator assembly 12 from the fluid stream. Similarly, an o-ring or other seal devise 74 can be provided on the spring guide 70 to further seal the biasing assembly 16 from the flow stream.

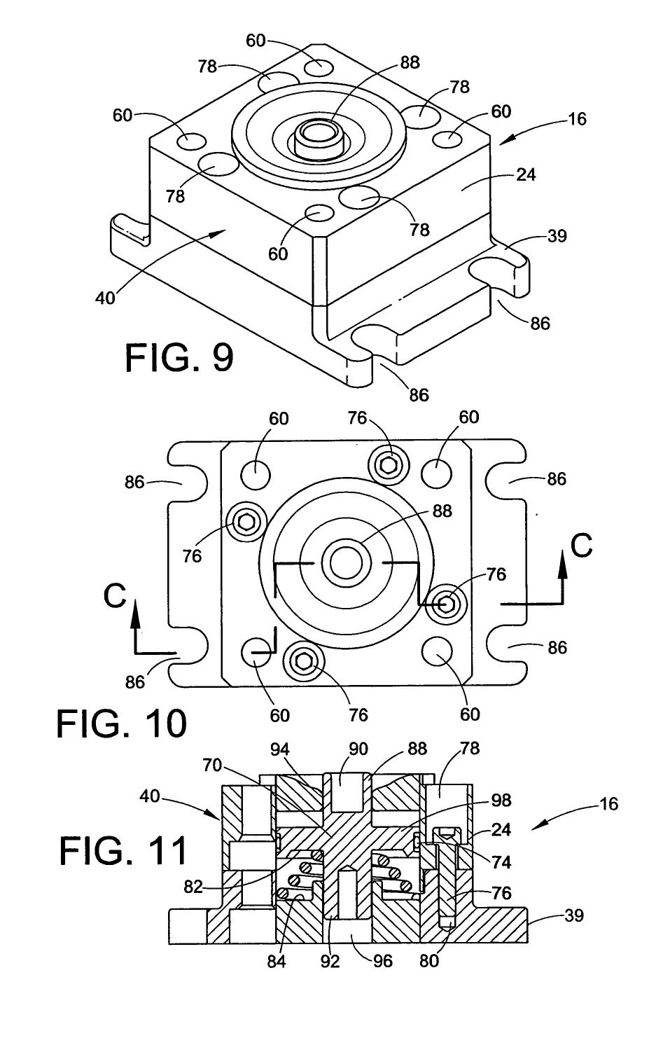

FIGS. 9 through 11 illustrate in greater detail the biasing assembly 16. As shown in FIG. 10 the biasing assembly 16 has four fasteners 76 entering the housing 24 though the top of the assembly 16. FIG. 11 shows the four fasteners 76 are bolts that pass though pre-formed holes 78 in the housing 24 and fasten into threaded holes 80 in the mounting plate 39 to couple the spring package 40 and the mounting plate 39 into a biasing assembly 16. This coupling forms a self-contained unit that contains the spring 26 and maintains the spring 26 in alignment. The conical spring 26 is maintained in compression between a lip 82 extending from the spring guide 70 and an upper surface 84 of the mounting plate 39. The mounting plate 39 allows the fluid flow assembly to be secured to a substrate by fasteners passing through the cutouts 86 in the mounting plate 39. Securing the fluid flow assembly typically allows for easier integration of the fluid flow assembly into a fluid flow system. In this embodiment, only four bolts 52 need to be removed in order to facilitate the changing of the biasing assembly 16. When these bolts 52 are removed, the biasing assembly 16 can be decoupled and replaced by a second biasing assembly 16 with a different biasing force by replacing the bots 52.

If the mounting plate 39 is optionally not used, then the spring 26 can be housed entirely within the spring package 40. In this instance, the spring package 40 would include a lower surface which could contact the spring 26 and maintain the spring 26 in compression between that surface and the lip 82 extending from the spring guide 70. In this optional configuration the spring package 40 would serve as a biasing assembly 16. Optionally the spring package 40 can be fabricated to include cutouts, similar to the cutouts 86 in the mounting plate 39, that would accommodate fasteners for mounting the fluid flow assembly 10 to a support or substrate.

The spring guide 70 includes an upper extension 88 having a recess 90 therein that receives part of the lower diaphragm stem 32 (best shown in FIG. 5). The spring guide 70 also includes a lower extension 92. The upper and lower extensions 88, 92 are journalled in respective passages 94, 96. Lubricant may be added to the inner surfaces of these passages 94, 96 so that the passages 94, 96 act as lubricated bearing surfaces for the spring guide 70. This helps maintain the spring guide 70 in proper alignment. The spring guide 70 further includes a guide portion 98. This guide portion 98 assists alignment of the spring 26 and lower stem 32 when the biasing assembly 16 is coupled to the fluid flow assembly 10. The guide portion 98 also may accommodate an o-ring 74. In additional to providing a back-up seal function, the o-ring 74 further may function as a dynamic dampening device when the flow path 20 is subjected to pressure surges. The spring 26 may also assist as a dynamic dampening device in cooperation with the o-ring 74. In addition, vent holes can be provided in the biasing assembly 16. Vent holes control the flow of ambient air in the biasing assembly 16 as the biasing member 26 is compressed. These vent holes may also serve as a dynamic dampener when the flow path 20 is subject to pressure surges.

In another aspect of the invention, the biasing assembly 16 can be configured so that a mounting plate 39 is coupled to the spring package 40 by fasteners that pass through pre-fabricated holes in the mounting plate 39 and are fastened in threaded holes in the biasing assembly housing 24. In this arrangement the biasing force can be changed by simply removing the mounting plate 39 from the spring package 40 and exchanging the spring 26 for a second spring with a different spring constant.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

1. A biasing assembly for use as a component of a fluid flow assembly, where the fluid flow assembly includes a fluid control member that is movable from a first position to a second position, the biasing assembly comprising:
a. a housing; and
b. a biasing member located within the housing;
wherein the biasing assembly is assembled with the fluid flow assembly such that the biasing member biases the fluid control member towards the first position; and
wherein the biasing assembly can be removed from the fluid flow assembly as a self-contained unit and replaced such that a biasing force applied to the fluid control member is changed.

2. The biasing assembly of claim 1, wherein the biasing member is a conical spring.

3. The biasing assembly of claim 2, wherein the conical spring is dimensioned and configured in a manner to provide an approximately constant spring force across the working displacement of the spring.

4. The biasing assembly of claim 1, further comprising a guide member located at least partially within the housing and operably coupled with the biasing member on a first end and operably coupled with the fluid control member on a second end.

5. The biasing assembly of claim 1, wherein when the biasing force is changed, the biasing member is replaced with a second biasing member, which applies a different biasing force.

6. The biasing member of claim 1, further comprising an aperture in the housing to accommodate the flow of gas in and out of the housing.

7. A biasing assembly for use as a component of a fluid flow assembly, where the fluid flow assembly includes a fluid control member that is movable from a first position to a second position, the biasing assembly comprising:
a. a housing;
b. a base member coupled to the housing; and
c. a biasing member located within the housing and the base member;
wherein the biasing assembly is assembled with the fluid flow assembly such that the biasing member biases the fluid control member towards the first position; and
wherein the biasing assembly can be removed from the fluid flow assembly as a self-contained unit and replaced such that a biasing force applied to the fluid control member is changed.

8. The biasing assembly of claim 7 wherein the base member includes at least one cutout to accommodate a fastener.

9. The biasing assembly of claim 7, wherein the biasing member is a conical spring, further wherein the conical spring is dimensioned and configured in a manner to provide an approximately constant spring force across the working displacement of the spring.

10. A fluid flow assembly comprising:
a. an actuator assembly;
b. a valve assembly comprising:
i. a valve body;
ii. a first port;
iii. a second port; and
iv. a sealing member assembled in the valve body wherein the actuator assembly is assembled with the valve assembly to move the sealing member from a first position towards a second position;
c. a self-contained biasing assembly comprising:
i. a housing; and
ii. a biasing member located within the housing;
wherein the self-contained biasing assembly is assembled with the valve assembly such that the biasing member biases the sealing member towards the first position.

11. The fluid flow assembly of claim 10, wherein the biasing member is a conical spring.

12. The fluid flow assembly of claim 11, wherein the conical spring is dimensioned and configured in a manner to provide an approximately constant spring force across the working displacement of the spring.

13. The fluid flow assembly of claim 10, further comprising a guide member in communication with the biasing member on a first end and in communication with the sealing member on a second end.

14. The fluid flow assembly in claim 10, wherein the self-contained biasing assembly is replaced with a second self-contained biasing assembly such that a biasing force biasing the sealing member is changed.

15. The fluid flow assembly in claim 10, wherein the biasing member is replaced with a second biasing member such that a biasing force biasing the sealing member is changed.

16. A fluid flow assembly comprising:
a. an actuator assembly;
b. a pressure regulator assembly comprising:
i. a body;
ii. a first port;
iii. a second port; and
iv. a fluid control member assembled in the body wherein the actuator assembly is assembled with the pressure regulator assembly to move the fluid control member from a first position towards a second position;
c. a self-contained biasing assembly comprising:
i. a housing; and
ii. a biasing member located within the housing;
wherein the self-contained biasing assembly is assembled with the pressure regulator assembly such that the biasing member biases the fluid control member towards the first position.

17. The fluid flow assembly of claim 16, wherein the biasing member is a conical spring.

18. The fluid flow assembly of claim 17, wherein the conical spring is dimensioned and configured in a manner to provide an approximately constant spring force across the working displacement of the spring.

19. A fluid flow assembly of claim 16, further comprising a guide member in communication with the biasing member on a first end and in communication with the sealing member on a second end.

20. A fluid flow assembly of claim 16, wherein the self-contained biasing assembly is replaced with a second self-contained biasing assembly such that a biasing force biasing the sealing member is changed.

21. A fluid flow assembly of claim 16, wherein the biasing member is replaced with a second biasing member such that a biasing force biasing the sealing member is changed.

22. A method of replacing a biasing member of a fluid flow device comprising:
a. assembling a first self-contained biasing assembly, with a first biasing force into a fluid control device;
b. disassembling the first self-contained biasing assembly from the fluid flow device; and
c. assembling a second self-contained biasing assembly, with a second biasing force, to the fluid flow device.

23. A method for changing biasing force applied to a fluid control member of a fluid flow assembly, comprising:
a. removing a self-contained biasing assembly from the fluid flow assembly, wherein the self-contained biasing assembly includes a first biasing member that applies a first biasing force to the fluid control member; and
b. assembling a self-contained biasing assembly with the fluid flow assembly that includes a second biasing member that applies a second biasing force to the fluid control member to change the biasing force applied to the fluid control member.

24. A method for changing biasing force applied to a fluid control member of a fluid flow assembly, comprising:
a. remove a base member from a self-contained biasing assembly, wherein the self-contained biasing assembly includes a first biasing member that applies a first biasing force to the fluid control member;
b. remove the first biasing member from the biasing assembly;
c. place a second biasing member with a second biasing force in the biasing assembly; and
d. replace the base member on the self-contained biasing assembly.
